(19) United States
(12) Patent Application Publication
(10) Pub. No.: US 2026/0361881 A1
(43) Pub. Date: Nov. 12, 2026

(54) METHOD FOR MANAGING DOWNLOADING, BY A READING TERMINAL, OF A DIGITAL CONTENT ITEM ACCESSIBLE IN MULTIPLE FORMATS

(71) Applicant: ORANGE, Issy-les-Moulineaux (FR)

(72) Inventors: Hervé MARCHAND, CHATILLON (FR); Olivier GASTE, CHATILLON (FR)

(21) Appl. No.: 19/125,942

(22) PCT Filed: Oct. 23, 2023
(86) PCT No.: PCT/EP2023/079514

§ 371 Date: Apr. 30, 2025

(30) Foreign Application Priority Data
Oct. 31, 2022 (FR) FR2211367

(51) Int. Cl. H04N 19/136; H04N 21/24

(52) U.S. Cl. CPC H04N 19/136; H04N 21/2407

(57) ABSTRACT

A method for managing downloading, from a communication network and by a terminal, of a digital content item accessible in multiple formats. The terminal includes multiple types of content decoders able to decode multiple content formats, respectively. The method includes, for various formats of a given content item, computing the respective waiting times before the content item is rendered, and selecting the content format for download depending on the result of the computing.

### CROSS-REFERENCE TO RELATED APPLICATIONS

This Application is a Section 371 National Stage Application of International Application No. PCT/EP 2023/079514, filed Oct. 23, 2023, and published as WO 2024/094465 A1 on May 10, 2024, not in English, which claims priority to and the benefit of French Patent Application No. 2211367, filed Oct. 31, 2022, the contents of which are incorporated herein by reference in their entireties.

### TECHNICAL FIELD

The field of the present disclosure is that of managing the playback of digital multimedia content items, namely digital video and/or audio content items. More precisely, the disclosure relates to managing the selection of the type of content items to be downloaded in a set of available content items.

The desired content items are encoded and therefore require decoders specific to the type of content in order to be decoded for the purpose of playback on a playback device.

A content item may be an image, an audio content item, a video content item, or any other similar content items. It will be seen hereinafter that the content item used to illustrate an exemplary aspect of the disclosure is an image.

### Prior Art

The playback, on a playback device, of a user interface which includes images requires the images to be made available on a server. The images are then downloaded, decoded by a decoder and displayed on a playback device.

To reduce the size of such images, they are compressed (or encoded) according to compression techniques known to the person skilled in the art. These compression techniques offer more or less optimized compression formats (JPG, WebP, GIF, PNG, etc.) which reduce the size (in KB) of a content item more or less depending on the compression technique used.

It is preferable to provide images having a high compression ratio because the downloading time is faster and therefore theoretically a shorter time before playback than with images having a lower compression ratio.

Presently, video reading devices are equipped with hardware image decoders (called accelerated image decoders or accelerators) which only support a limited number of compression formats. The reading terminals which do not have a hardware decoding accelerator perform the decoding via the CPU (Central Processing Unit) processor of the reading terminal, in a software-based manner, which requires much more decoding time than when it is performed via a hardware decoder. It may therefore happen that an image having a high compression ratio, and therefore downloaded rapidly, suffers a delay in playback due to the absence of the decoder specific to this type of image on the reading terminal. The compression formats WebP and JPEG (Joint Photographic Experts Group) are known, for example. The WebP format is an image format which has a better compression ratio than the JPEG format; there may be a ratio of two between the weight in kilobytes of a WebP image and that of a JPEG image for an equivalent playback quality. Time is therefore saved when retrieving WebP images from a server from which it is downloaded because the size of the image in KB is much smaller for equal quality. However, the time before playback of a WebP image is optimal if a decoder specific to the WebP format is installed on the reading terminal; yet, presently, this is not always the case. Specifically, only the most recent or high-end devices are equipped with such a decoder. If the reading terminal is not equipped with a hardware decoder, of GPU (Graphics Processing Unit) type, specific to the WebP format, the decoding is then done by the processor of the reading terminal, in a software-based manner, this requiring much more time.

An exemplary aspect of the present disclosure aims to improve the situation.

### SUMMARY

An exemplary aspect of the present disclosure relates to a method for managing downloading, from a communication network, by a terminal, of a digital content item accessible in multiple formats, the terminal comprising multiple types of content decoders able to decode multiple content formats, respectively, characterized in that said method comprises, for various formats of the same content item, calculating the respective waiting times before the content item is played back, and in that the content format selected to be downloaded depends on the result of the calculation.

An aspect of the disclosure is therefore based on calculating the foreseeable waiting time before playback in order to decide, when multiple formats of the same content item are available, the content format to be downloaded and played back. The selected format will not necessarily be the format associated with the best compression ratio, it being possible for a content format associated with a lower compression ratio to be associated with a lesser waiting time before playback.

In a context where the speed of playback is desired, an aspect of the disclosure ensures an optimal time before playback. For example, it may therefore be more beneficial to retrieve JPEG images, rather than WebP images, which though larger in kilobyte size to download are faster to decode.

It will be seen below that the example chosen to illustrate an aspect of the disclosure aims for the shortest possible time before playback. However, the disclosure is not limited to the shortest target time before playback. The target time before playback may be the longest time, or another time chosen depending on the context.

According to a first embodiment of the method, the calculation is carried out for content items the associated decoder of which is present in the reading terminal. This first mode makes it possible to exclude the content items that would be decoded by the CPU processor, which processor uses up more decoding time than a hardware decoder.

According to yet another, second particular embodiment of the disclosure, which could be implemented alternatively to or together with the previous embodiment, the calculation of waiting time before playback comprises a first calculation of a downloading time of the content item, and a second calculation of a decoding time of the content item. According to this second embodiment, the result of the first calculation is reused several times during subsequent calculations of waiting times before playback. This mode makes it possible to save time on calculating the foreseeable time before playback by retaining the first calculation several times during successive calculations of estimating waiting times before playback and therefore by not recalculating the first time each time. Specifically, in a network in which the bandwidth fluctuates very little, the first calculation does not need to be recalculated for each calculation. This time saving accelerates the selection of the content item and therefore the playback thereof.

According to one variant of the second mode, the content item is downloaded via a communication network having a fluctuating bandwidth; in this configuration, the result of the first calculation is reused as long as the bandwidth lies within a given bandwidth range. This third mode reduces the number of times the first calculation is carried out; this reduction in the number of calculations carried out accelerates the selection of the content item and therefore the playback thereof.

According to a hardware aspect, an aspect of the disclosure relates to an entity for managing downloading, from a communication network, by a terminal, of a digital content item accessible in multiple formats, the terminal comprising multiple types of content decoders able to decode multiple content formats, respectively, characterized in that it comprises a processor configured to, for various formats of the same content item, calculate the respective waiting times before the content item is played back, and to select the content format selected to be downloaded depending on the result of the calculation.

According to another hardware aspect, an aspect of the disclosure relates to a reader terminal comprising a managing entity as defined above.

According to another hardware aspect, one aspect of the disclosure is a computer program able to be implemented on a managing entity as defined above, the program comprising code instructions which, when executed by a processor, perform the steps of the management method which are defined above.

According to another hardware aspect, one aspect of the invention is a data medium on which at least one series of program-code instructions for executing a management method as defined above has been stored.

The medium in question may be any entity or device which is capable of storing the program. For example, the medium may comprise a storage means, such as a ROM, for example a CD-ROM or a microelectronic circuit ROM, or else a magnetic recording means, for example a hard disk. Moreover, the information medium may be a transmissible medium such as an electrical or optical signal, which may be routed via an electrical or optical cable, by radio or by other means. The program according to an aspect of the disclosure may in particular be downloaded over the Internet. Alternatively, the information medium may be an integrated circuit into which the program is incorporated, the circuit being designed to execute or to be used in the execution of the method in question.

### BRIEF DESCRIPTION OF THE DRAWINGS

One or more aspects of the disclosure will be better understood on reading the following description, which is given by way of example and with reference to the appended drawings, in which:

FIG. 1 shows an architecture for progressive downloading over the Internet based on the use of adaptive streaming according to one embodiment of the method of the disclosure;

FIG. 2 schematically illustrates the hardware structure of a reader terminal for reading multimedia streams;

FIG. 3 illustrates steps of one embodiment.

### DETAILED DESCRIPTION OF EXEMPLARY ASPECTS OF THE DISCLOSURE

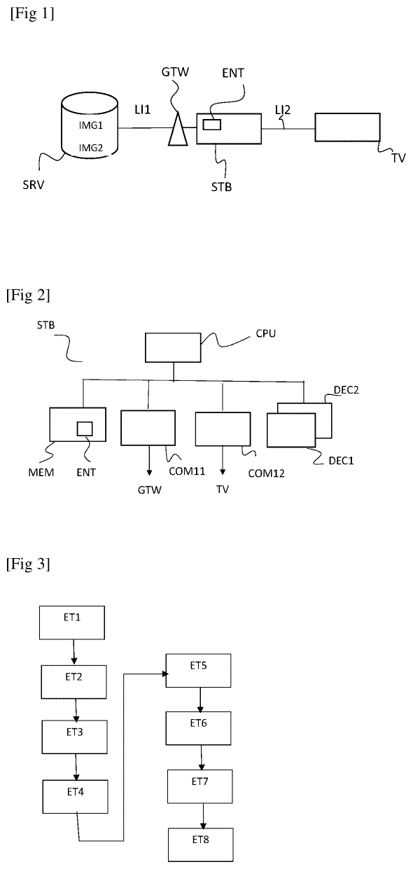

A computer system SYS comprising a server SRV from which content items may be downloaded, and a reading terminal STB from which content items may be read, will now be presented with reference to FIG. 1.

Various types of digital content items IMG1/IMG2 that have been encoded or compressed in various ways are accessible from the server SRV.

FIG. 2 schematically illustrates a reading terminal STB. The latter has a conventional architecture of a computer; conventionally, the decoder comprises memories M associated with a processor CPU. The memories may be read-only memories (ROMs) or random-access memories (RAMs) or else flash memories. The decoder communicates with the server either directly through a wide-area network WAN or indirectly through a home gateway GTW and the wide-area Internet network WAN. Communication via a LAN network is performed via a module COM11 connected to the processor CPU, ensuring local wireless communication of Wi-Fi type with the home gateway GTW.

The reading terminal STB further comprises a download module for requesting a download of a content item stored on the server SRV.

In our example, the reading terminal STB is connected to a television TV via a communication module COMM2 of the HDMI connection type.

The encoded content items IMG1/IMG2 stored on the server SRV are able to be decoded by specific decoders DEC1 and DEC2, respectively. When a content item is downloaded and received by the reading terminal, a decoder decodes the content item and requests playback of the content item.

The decoding may be performed either by a hardware decoder or by a software decoder; the software decoder is managed by the processor while a hardware decoder is equipped with a processor separate from the processor CPU.

In other words, software decoding uses the processor CPU to decode and read content, while hardware decoding DEC1/DEC2 of GPU type is mainly based on a graphics processing unit, or GPU, which is more efficient than a processor CPU at processing multimedia content items.

According to an aspect of the disclosure, a managing entity ENT performs, for multiple content formats, a calculation of respective waiting times before the content item is played back. This calculation makes it possible to obtain an estimate of the times preceding the playback of the content item in question. A content item is then selected depending on the result of the calculation. The selected content item is then downloaded and played back.

It is assumed that the server SRV stores images IMG1 and IMG2 encoded according to two respective encoding techniques. In our example, the images are a JPEG image and a WebP image.

The WebP format is an image format which has a higher compression ratio than the JPEG compression ratio. There is a ratio of two between the weight in KB of a WebP image compared to a JPEG image for equivalent quality. There is therefore a definite benefit to prioritizing downloading a content item encoded in the WebP format rather than JPEG when optimal image quality is sought.

Most terminals are equipped with hardware decoders of JPEG type. This is not the case for WebP images; only a few reading or high-end terminals have built-in WebP hardware decoders. If there is no specific WebP hardware decoder, the decoding is done by default via the software decoder of the processor CPU, this requiring much more processing time, much more than with a WebP decoder. It is understood that, depending on whether or not the reading terminal is equipped with the hardware decoder, it may sometimes be more beneficial to recover a JPEG image that is heavier in size than a WebP image but faster to decode due to the absence of a WebP decoder.

In our example, it is assumed that the terminal has, in addition to the software decoder, a JPEG hardware decoder and that it is not equipped with a WebP decoder.

FIG. 3 illustrates steps of an embodiment illustrating an aspect of the disclosure. The method comprises multiple steps referenced ETn (n=1, . . . , 8).

During a first step ET1, the decoder reading terminal STB receives a request for access to an image.

As was seen above, the same image is encoded in multiple formats. During a second step ET2, the decoder reading terminal STB retrieves information for each image format, the size in kilobytes of the various encoded images and the types of formats, namely in our example JPEG and WebP. Other information may be retrieved such as an image resolution, or other information which could have an impact on the waiting time before playback.

During a third step ET3, the reading terminal calculates respective waiting times before the content item is played back for each image format; during this calculation, a first calculation estimates, as a function of the current bandwidth, the downloading time as a function of the size of the chosen image and the current bandwidth. The bandwidth may be determined by means of an algorithm known to the person skilled in the art. Such an algorithm is, for example, a so-called adaptive progressive downloading algorithm, also known as HTTP adaptive streaming (HAS).

It is briefly recalled that, more often than not, the general principle of such HAS algorithms is based on downloading an encoded segment at the lowest encoding rate proposed in a manifest (also called description file by the person skilled in the art), and on evaluating the time to retrieve this first segment. This retrieval time may be equated with the time to download the segment.

Suppose that the image encoded in JPEG has a size of 1.5 MB (MB=Megabytes). Suppose also that the bandwidth of the user (calculated by an algorithm of HAS type) is 10 MB. The downloading time of the JPEG image will therefore be 0.15 second. The same image encoded in WebP has a size of 1 MB and requires a downloading time of 0.1 second.

Then, the second calculation consists in determining, according to the capabilities of the terminal, namely according to the presence or absence of the hardware decoder specific to the JPEG or WebP image, and the characteristics of the image (resolution/weight in KB), the foreseeable decoding time of the image. This second calculation could also comprise the delay in transmitting the decoded image until the image is played back; however, it is considered in this example that this delay is of no interest because it is substantially the same for all the decoded images and negligible with respect to the decoding delay.

In general, retrieving an image on a server comprises two times, namely the downloading time and the decoding time; the other times, namely the transmission time of a request to download an image, or the transmission time of the decoded image to the screen, or any other times are not taken into account in our example because they are of substantially equal times regardless of the selected image format.

The sum of the two preceding results, results from the first and second calculations, corresponds to a time before an image is played back.

In our example, concretely, by virtue of the second calculation, it is determined that the JPG image may be decoded by the JPEG hardware decoder in 0.05 sec and that the WebP image may for its part be decoded by the processor CPU in 0.25 sec.

The overall calculation combining the downloading time and the decoding time gives the following results:
For the image IMG1, the foreseeable downloading time added to the foreseeable decoding time of the JPG image (0.15+0.05) gives 0.155 sec of time before playback.
For the image IMG2, the foreseeable downloading time added to the foreseeable decoding time of the JPG image downloading time added to the decoding of the WebP image (0.1+0.25) gives 0.35 sec of waiting time before playback.

If the need is to obtain an image as quickly as possible, the JPG image is selected because the foreseeable waiting time before playback is much shorter than with the WebP image. In our example, during a fourth step ET4, the managing entity ENT therefore selects the JPEG image to be downloaded, which image is of lower quality but has the shortest time before playback.

During a fifth step ET5, the reading terminal STB requests from the server a download of the JPEG image.

During a sixth step ET6, the reading terminal STB receives the selected JPEG image and decodes this image during a seventh step.

During an eighth step ET8, the JPEG image is played back.

It is understood here that, in the embodiment chosen, the reading terminal ensures an optimal waiting time before playback.

The method described above may be subject to variants.

According to a first variant, in order to save time in the calculation, the result of the first calculation may be retained several times during subsequent calculations. Specifically, in a network in which the bandwidth fluctuates very little, performing the overall calculation (first calculation and second calculation) without performing the first calculation, namely the calculation of the downloading time, each time, decreases the calculation time to the calculation time associated with the decoding time.

According to a second variant, the time before playback is based solely on the second time associated with the type of decoder present on the reading terminal. In this mode, the downloading time is not taken into account.

According to a third variant, an image IMG1 and IMG2 not having a specific decoder present in the reading terminal STB is not accessible for selection for downloading. Taking the example above in which the reading terminal only comprises the JPEG decoder and no WebP decoder, in this case the WebP image is not able to be selected to be downloaded. Only the JPEG image is accessible for download. This variant is beneficial when it is considered that the time for decoding performed by the processor CPU is, in all cases, greater than the time for decoding performed by a hardware decoder.

Lastly, it is also specified here that the term “entity” may correspond either to a software component or to a hardware component or to a set of software and hardware components, a software component itself corresponding to one or more computer programs or subprograms or, more generally, to any element of a program which is able to implement a function or a set of functions as described for the modules under consideration. In the same way, a hardware component corresponds to any element of a hardware assembly which is able to implement a function or a set of functions for the module under consideration (integrated circuit, chip card, memory card, etc.).

Although the present disclosure has been described with reference to one or more examples, workers skilled in the art will recognize that changes may be made in form and detail without departing from the scope of the disclosure and/or the appended claims.

1. A management method comprising:
managing downloading, from a communication network, by a reading terminal, of a digital content item accessible in multiple formats, the terminal comprising multiple types of content decoders able to decode multiple content formats, respectively, wherein the managing comprises, for various formats of the same digital content item, calculating respective waiting times before the digital content item of the various formats is played back, and selecting the content format to be downloaded depending on a result of the calculation.

2. The management method as claimed in claim 1, wherein the calculation is carried out for the digital content items that have a format associated with a decoder which is present in the reading terminal.

3. The management method as claimed in claim 1, wherein the calculation of a respective waiting time before playback comprises a first calculation of a downloading time and a second calculation of a decoding time, and wherein a result of the first calculation is reused several times during subsequent calculations of waiting times before playback.

4. A management entity for managing downloading, from a communication network, by a terminal, of a digital content item accessible in multiple formats, the terminal comprising multiple types of content decoders able to decode multiple content formats, respectively, wherein the management entity comprises:
a processor configured to, for various formats of the same digital content item, calculate respective waiting times before the digital content item of the various formats is played back, and select the content format to be downloaded depending on the a result of the calculation.

5. A reader terminal comprising the managing entity as claimed in claim 4.

6. (canceled)

7. A non-transitory computer readable data medium on which at least one series of program-code instructions is stored, which when executed by at least one processor of a management entity configure the management entity to execute a method comprising:
managing downloading, from a communication network, by a reading terminal, of a digital content item accessible in multiple formats, the terminal comprising multiple types of content decoders able to decode multiple content formats, respectively, wherein the managing comprises, for various formats of the same digital content item, calculating respective waiting times before the digital content item of the various formats is played back, and selecting the content format to be downloaded depending on a result of the calculation.
